(19) United States
(12) Patent Application Publication
(10) Pub. No.: US 2012/0113219 A1
(43) Pub. Date: May 10, 2012

(54) IMAGE CONVERSION APPARATUS AND DISPLAY APPARATUS AND METHODS USING THE SAME

(75) Inventors: Ju-yong CHANG, Seoul (KR); Jin-sung LEE, Suwon-si (KR); Jong-sul MIN, Suwon-si (KR); Sung-jin KIM, Suwon-si (KR)

(73) Assignee: SAMSUNG ELECTRONICS CO., LTD., Suwon-si (KR)

(21) Appl. No.: 13/244,327

(22) Filed: Sep. 24, 2011

(30) Foreign Application Priority Data
Nov. 10, 2010 (KR) 10-2010-0111278

(51) Int. Cl. H04N 13/00

(52) U.S. Cl. 348/43; 348/E13.068

(57) ABSTRACT

A method for converting an image in an image conversion apparatus is provided. The method includes receiving a stereo image, down-scaling the stereo image, performing stereo-matching by applying adaptive weight to the down-scaled stereo images, generating a depth map according to the stereo-matching, up-scaling the depth map by referring to an input image of original resolution, and generating a plurality of multi-view images by performing depth-image-based rendering with respect to the up-scaled depth map and the input image of original resolution. Accordingly, a plurality of multi-view images may be obtained with ease.

### CROSS-REFERENCE TO RELATED APPLICATION

This application claims priority from Korean Patent Application No. 10-2010-0111278, filed on Nov. 10, 2010 in the Korean Intellectual Property Office, the disclosure of which is incorporated herein by reference.

### BACKGROUND

1. Field

Methods and apparatuses consistent with exemplary embodiments relate to an image conversion apparatus and a display apparatus and methods using the same, and more particularly, to an image conversion apparatus which converts a stereo image into a multi-view image and a display apparatus and methods using the same.

2. Description of the Related Art

With the advancement of electronic technologies, various household appliances having multiple functions have been produced. One of those household appliances is a display apparatus, such as a television.

Recently, a three-dimensional (3D) display apparatus which allows a user to watch a 3D image has also become popular. A 3D display apparatus may be divided into a glasses-type system or a non-glasses-type system according to whether a user requires glasses for watching the 3D image.

One example of a glasses-type system is a shutter glasses method which enables a person to perceive a stereoscopic sense by blocking a left eye and a right eye alternately as a display apparatus outputs a stereo image alternately. In such a 3D display apparatus employing a shutter glasses method, if a 2D image signal is input, the input signal is converted into a left eye image and a right eye image and output alternately. On the other hand, if a stereo image signal including a left eye image and a right eye image is input, the input signal is output alternately to create the 3D image.

A non-glasses-type system allows a user to perceive a stereoscopic sense without wearing glasses by shifting a multi-view image spatially and displaying the shifted image. As such, the non-glasses-type system is advantageous in that it allows a user to view a 3D image without wearing glasses. To do so, however, a multi-view image should be provided.

A multi-view image refers to an image in which a subject in the image is viewed from a plurality of viewpoints. In order to generate such a multi-view image, a plurality of image signals should be generated using a plurality of cameras, which is practically difficult since not only producing a multi-view image is not easy and costly but also a lot of bandwidths are required when contents are transmitted. Therefore, a glasses-type system has been mostly developed until recently, and development of contents has also been focused on 2D or stereo contents.

However, there have been continuous needs for a non-glasses-type system which enables a user to watch a 3D image without glasses. In addition, a multi-view image may also be used in a glasses-type system. Accordingly, a technology for providing a multi-view image using an existing stereo image is required.

### SUMMARY

An aspect of the exemplary embodiments relates to an image conversion apparatus which is capable of generating a multi-view image using a stereo image and a display apparatus and methods using the same.

A method for converting an image in an image conversion apparatus, according to an exemplary embodiment, includes down-scaling a stereo image, performing stereo-matching by applying adaptive weights to the down-scaled stereo images, generating a depth map according to the stereo-matching, up-scaling the depth map by referring to an input image of original resolution, and generating a plurality of multi-view images by performing depth-image-based rendering with respect to the up-scaled depth map and the input image of original resolution.

The stereo-matching may include applying a window having a predetermined size to each of a first input image and a second input image of the stereo images, sequentially, calculating a similarity between a central pixel and a peripheral pixel in the window applied to each one of the first input image and the second input image, and searching for matching points between the first input image and the second input image by applying different adaptive weights to the central pixel and the peripheral pixel according to the similarity between the central pixel and the peripheral pixel.

The depth map may be an image having a different grey level according to distance difference between the matching points.

The weight may be set to have a size in proportion to similarity of the central pixel, and the grey level may be set as a value in inverse proportion to distance difference between the matching points.

The up-scaling the depth map may include searching similarity between the depth map and the input image of original resolution and performing up-scaling by applying weight with respect to the searched similarity.

The plurality of multi-view images may be displayed by a non-glasses 3D display system to represent a 3D screen.

An image conversion apparatus, according to an exemplary embodiment, includes a down-scaling unit which down-scales a stereo image, a stereo-matching unit which performs stereo-matching by applying adaptive weight to the down-scaled stereo images and generates a depth map according to the stereo-matching, an up-scaling unit which up-scales the depth map by referring to an input image of original resolution, and a rendering unit which generates a plurality of multi-view images by performing depth-image-based rendering with respect to the up-scaled depth map and the input image of original resolution.

The stereo-matching unit may include a window generating unit which applies a window having a predetermined size to each of a first input image and a second input image of the stereo images, sequentially, a similarity-calculating unit which calculates similarity between a central pixel and a peripheral pixel in the window, a search unit which searches a matching point between the first input image and the second input image by applying a different weight according to the similarity, and a depth map generating unit which generates a depth map using distance between the searched points.

The depth map may be an image having a different grey level according to distance difference between the matching points.

The weight may be set to have a size in proportion to similarity with the central pixel, and the grey level may be set as a value in inverse proportion to distance difference between the matching points.

The up-scaling unit may search similarity between the depth map and the input image of original resolution and perform up-scaling by applying weight with respect to the searched similarity.

The image conversion apparatus may further include an interface unit which provides the plurality of multi-view images to a non-glasses 3D display system.

A display apparatus, according to an exemplary embodiment, includes a receiving unit which receives a stereo image, an image conversion processing unit which generates a depth map by applying adaptive weight after down-scaling the stereo image and generates a multi-view image through up-scaling using a generated depth map and a resolution image, and a display unit which outputs the multi-view image generated by the image conversion processing unit.

The image conversion processing unit may include a down-scaling unit which down-scales the stereo image, a stereo-matching unit which performs stereo-matching by applying adaptive weight with respect to the down-scaled stereo images and generates a depth map according to a result of the stereo-matching, an up-scaling unit which up-scales the depth map by referring to an input image of original resolution, and a rendering unit which generates a plurality of multi-view images by performing depth-image-based rendering with respect to the us-scaled depth map and the input image of original resolution.

As such, according to various exemplary embodiments, a multi-view image may be generated easily from a stereo image and utilized.

### BRIEF DESCRIPTION OF THE DRAWINGS

The above and/or other aspects of the inventive concept will be more apparent by describing certain exemplary embodiments with reference to the accompanying drawings, in which:

FIG. 1 is a block diagram illustrating configuration of an image conversion apparatus according to an exemplary embodiment;

FIG. 2 is a block diagram illustrating an example of configuration of a stereo matching unit according to an exemplary embodiment;

FIG. 3 is a block diagram illustrating configuration of an image conversion apparatus according to another exemplary embodiment;

FIG. 4 is a block diagram illustrating configuration of a display apparatus according to an exemplary embodiment;

FIGS. 5 to 9 are views to explain a process of converting an image according to an exemplary embodiment;

FIGS. 10 and 11 are views illustrating a non-glasses-type 3D system to which an image conversion apparatus is applied and a display method thereof according to an exemplary embodiment;

FIG. 12 is a flowchart to explain a method for converting an image according to an exemplary embodiment; and

FIG. 13 is a flowchart to explain an example of a stereo matching process.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

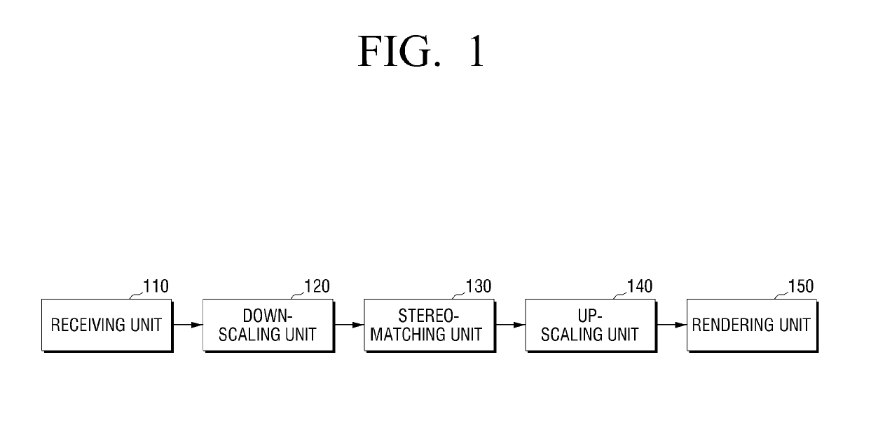

FIG. 1 is a block diagram illustrating configuration of an image conversion apparatus according to an exemplary embodiment. According to

FIG. 1, the image conversion apparatus comprises a receiving unit 110, a down-scaling unit 120, a stereo matching unit 130, an up-scaling unit 140, and a rendering unit 150.

The receiving unit 110 receives a stereo image. The stereo image refers to more than two images. For example, the stereo image may be a first input image and a second input image which are two images of one subject photographed from two different angles. In the exemplary embodiment, the first input image will be referred to as a left eye image (or left image) and the second input image will be referred to as a right eye image (or right image) for convenience of explanation.

Such a stereo image may be provided from various sources. For example, the receiving unit 110 may receive a stereo image from a broadcast channel via cable or wirelessly. In this case, the receiving unit 110 may comprise various components such as a tuner, a demodulator, and equalizer.

In addition, the receiving unit 110 may receive a stereo image which is reproduced by a recording medium reproducing unit (not shown) reproducing various recording media such as a DVD, Blu-ray disk, and a memory card, or directly receive a photographed stereo image from a camera. In this case, the receiving unit 110 may comprise various interfaces such as an USB interface.

The down-scaling unit 120 performs down-scaling on a stereo image which is received through the receiving unit 110. That is, in order to convert a stereo image into a multi-view image, it is desirable to reduce computational burden. To do so, the down-scaling unit 120 down-scales an input stereo image to reduce its data size, thereby reducing computational burden.

Specifically, the down-scaling unit 120 lowers resolution of a left eye image and a right eye image included in a stereo image as much as a predetermined constant number (n) of times, respectively. For example, down-scaling may be performed by removing pixels at predetermined time intervals or representing a pixel block with a predetermined size as the average value or representative value of pixels therein. Accordingly, the down-scaling unit 120 may output low-resolution left eye image data and low-resolution right eye image data.

The stereo matching unit 130 performs a stereo matching operation to search matched points between a down-scaled left eye image and a down-scaled right eye image. In this case, the stereo matching unit 130 may perform the stereo matching operation using adaptive weight.

Since a left eye image and a right eye image are images of one subject photographed from different viewpoints, there may be a difference in the images due to the different viewpoints. For example, a subject is overlapped with a background in a left eye image while the subject is somewhat apart from the background in a right eye image. Therefore, adaptive weights may be applied to increase the weights of pixels having a pixel value within a predetermined scope with respect the subject and decrease the weights of pixels having a pixel value beyond the predetermined scope. Accordingly, the stereo matching unit 130 may apply the adaptive weights to the left eye image and the right eye image, respectively, and determine whether to perform a matching operation by comparing the adaptive weights. As such, by using adaptive weights, matching accuracy may be enhanced since determining a matching result as low correlation despite a right corresponding point may be prevented.

The stereo matching unit 130 may generate a depth map according to a matching result.

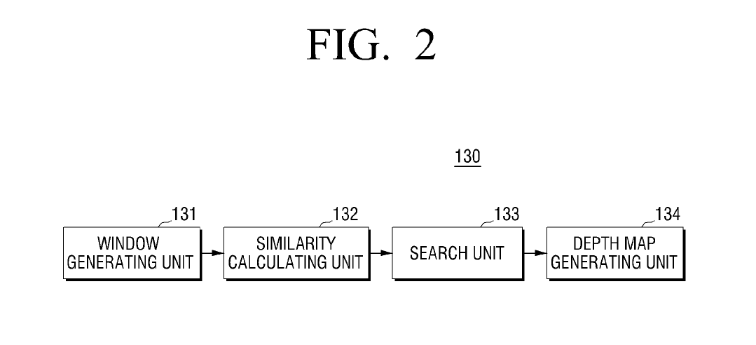

FIG. 2 is a block diagram illustrating an example of a configuration of the stereo matching unit 130 according to an exemplary embodiment. According to FIG. 2, the stereo matching unit 130 comprises a window generating unit 131, a similarity calculating unit 132, a search unit 133, and a depth map generating unit 134.

The window generating unit 131 generates a window having a predetermined size (n*m) and applies the generated window to a down-scaled left eye image and a down-scaled right eye image, respectively.

The similarity calculating unit 132 calculates similarity between a central pixel and a peripheral pixel in the window. For example, if the window in which a first pixel is designated as the center is applied to the first pixel in a left eye image, the similarity calculating unit 132 checks a pixel value of pixels surrounding the central pixel in the window. Subsequently, the similarity calculating unit 132 determines a peripheral pixel having a pixel value within a predetermined scope with respect to the pixel value of the central pixel as a similar pixel, and determines a peripheral pixel having a pixel value beyond the predetermined scope as a non-similar pixel.

The search unit 133 searches for a matching point between a left eye image and a right eye image by applying different weights based on the similarity calculated by the similarity calculating unit 132.

The weights may increase in proportion to the similarity. For example, if two weights, that is, 0 and 1, are applied, ‘1’ may be given to a peripheral pixel which is similar to a central pixel and ‘0’ may be given to a peripheral pixel which is not similar to the central pixel. If four weights, that is, 0, 0.3, 0.6, and 1, are applied, pixels may be divided into four groups according to the scope of difference in pixel value between the pixels and a central pixel, and ‘0’ may be given to a peripheral pixel having the greatest difference, ‘0.3’ may be given to a peripheral pixel having the next greatest difference, ‘0.6’ may be given to a peripheral pixel having the next greatest difference, and ‘1’ may be given to a peripheral pixel having the least difference or in a group with the same pixel value as the central pixel, and a weight map may be generated accordingly.

The search unit 133 may produce a matching level using the following equation.

α=SUM(L_image*W1−R_image*W2)² [Equation 1]

In Equation 1, SUM( ) refers to a function representing a summation of calculation results for the entire pixels in the window, L_image and R_image refer to a pixel value of a left eye image and a pixel value of a right eye image, respectively, and W1 and W2 refer to weights determined for each of a corresponding pixel. The search unit 133 may search a matching window between a left eye image and a right eye image by comparing each window of the left eye image with the entire window of the right eye image as in Equation 1.

The depth map generating unit 134 generates a depth map based on distance between matching points searched by the search unit 133. That is, the depth map generating unit 134 compares a location of ‘a’ pixel constituting a subject in a left eye image with a location of ‘a’ pixel in a right eye image and calculates the difference. Accordingly, the depth map generating unit 134 generates an image having a gray level corresponding to the calculated difference, that is, a depth map.

The depth may be defined as a distance between a subject and a camera, a distance between a subject and recording media (for example, a film) where an image of the subject are formed, or a degree of stereoscopic sense. Therefore, if a distance between a point of a left eye image and a point of a right eye image is great, stereoscopic sense increases to that extent. The depth map illustrates such change in depth in a single image. Specifically, the depth map may illustrate depth using a grey level which differs according to a distance between matching points in a left eye image and a right eye image. That is, the depth map generating unit 134 may generate a depth map in which a point having a large distance difference is bright and a point having a small distance difference is dark.

Referring back to FIG. 1, if a depth map is generated by the stereo matching unit 130, the up-scaling unit 140 up-scales the depth map. Herein, the up-scaling unit 140 may up-scale a depth map by referring to an input image of original resolution (that is, a left eye image or a right eye image), That is, the up-scaling unit 140 may perform up-scaling while applying different weight to each point of a depth map in a low-resolution state, considering brightness information of an input image and structure of color values.

For example, the up-scaling unit 140 may divide an input image of original resolution by block and review similarity by comparing pixel values in each block. Based on the review result, a weight window may be generated by applying high weight to a similar portion. Subsequently, if up-scaling is performed by applying the generated weight window to a depth map, critical portions in the depth map may be up-scaled by applying high weight. As such, adaptive up-scaling may be performed by considering an input image of original resolution.

The rendering unit 150 generates a plurality of multi-view images by performing depth-image-based rendering with respect to an up-scaled depth map and the input image of original resolution. In this case, the rendering unit 150 may generate an image viewed from one viewpoint and then infer and generate an image viewed from another viewpoint using the image and a depth map. That is, if one image is generated, the rendering unit 150 infers travel distance on a recording medium (that is, a film) when a viewpoint changes using focal distance and depth of a subject with reference to the generated image. The rendering unit 150 generates a new image by moving a location of each pixel of a reference image according to inferred travel distance and direction. The generated image may be an image of a subject viewed a viewpoint which is a predetermined angle apart from a reference image. As such, the rendering unit 150 may generate a plurality of multi-view images.

Meanwhile, the image conversion apparatus in FIG. 1 may be embodied as a single module or chip and amounted on a display apparatus.

Alternatively, the image conversion apparatus may be embodied as independent apparatus which is provided separately from a display apparatus. For example, the image conversion apparatus may be embodied as an apparatus such as a set-top box, a PC, or an image processor. In this case, an additional component may be required to provide a generated multi-view image to a display apparatus.

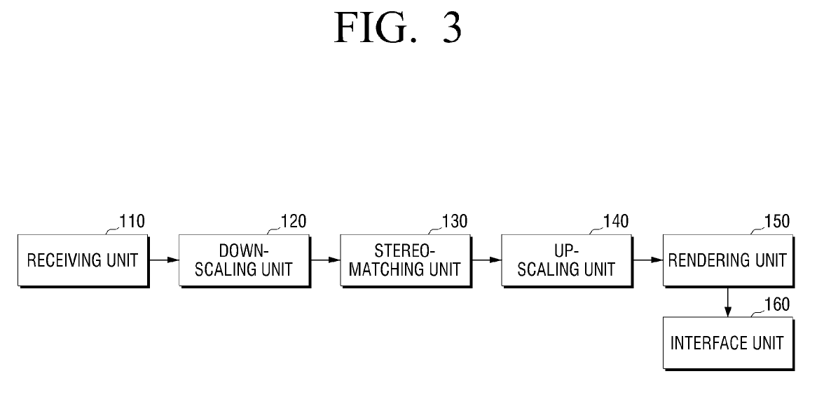

FIG. 3 is a block diagram to explain a case where an image conversion apparatus is provided separately from a display apparatus. According to FIG. 3, an image conversion apparatus may further comprise an interface unit 160 in addition to a receiving unit 110, a down-scaling unit 120, a stereo matching unit 130, an up-scaling unit 140, and a rendering unit 150.

The interface unit 160 is a component to transmit a plurality of multi-view images generated by the rendering unit 150 to an external display apparatus. For example, the interface unit 160 may be embodied as an USB interface unit or a wireless communication interface unit using a wireless communication protocol. In addition, the above-described display apparatus may be a non-glasses-type 3D display system.

Since the other components excluding the interface unit 160 are the same as those described above with reference to FIG. 1, further explanation will not be provided.

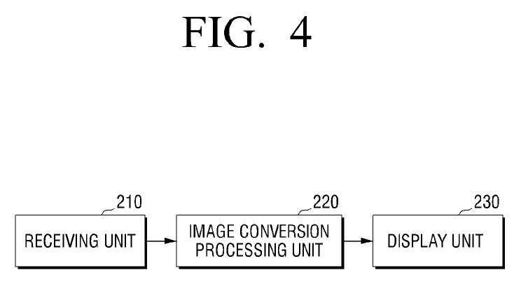

FIG. 4 is a block diagram illustrating a configuration of a display apparatus according to an exemplary embodiment. The display apparatus in FIG. 4 may be an apparatus capable of displaying a 3D image. Specifically, the display apparatus in FIG. 4 may be of various types, such as TV, PC monitor, digital photo frame, PDP, and a mobile phone.

According to FIG. 4, a display apparatus comprises a receiving unit 210, an image conversion processing unit 220, and a display unit 230.

The receiving unit 210 receives a stereo image from an external source.

The image conversion processing unit 220 performs down-scaling on the received stereo image and generates a depth map by applying adaptive weight. Subsequently, a multi-view image is generated through up-scaling using the generated depth map and the image of original resolution.

The display unit 230 may form a 3D screen by outputting a multi-view image generated by the image conversion processing unit 220. For example, the display unit 230 may divide a multi-view image spatially and output the divided image so that a user may perceive a 3D image by sensing some distance from a subject without wearing glasses. In this case, the display unit 230 may be embodied as a display panel using a parallax barrier technology or a lenticular technology. Otherwise, the display unit 230 may be embodied to create a stereoscopic sense by outputting a multi-view image alternately. That is, the display apparatus may be embodied as either a non-glasses system or a glasses system.

Meanwhile, the image conversion processing unit 220 may have the configuration illustrated in FIGS. 1 to 3. That is, the image conversion processing unit 220 may comprise a down-scaling unit which down-scales a stereo image, a stereo matching unit which performs stereo matching by applying adaptive weight with respect to down-scaled stereo images and generates a depth map according to the stereo matching result, an up-scaling unit which up-scales the depth map by referring to an input image of original resolution, and a rendering unit which generates a plurality of multi-view images by performing depth-image-based rendering with respect to the up-scaled depth map and the input image of original resolution. The detailed configuration and operation of the image conversion processing unit 220 are the same as those described above with respect to FIGS. 1 to 3 and thus, further explanation will not be provided.

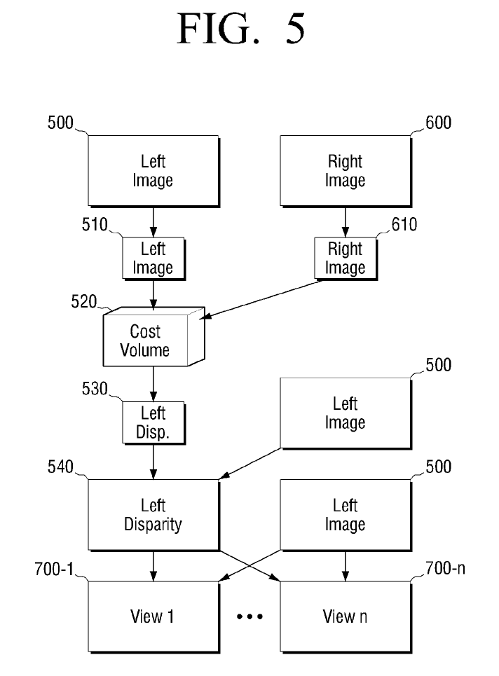

FIGS. 5 to 9 are views to explain a process of converting an image according to an exemplary embodiment.

According to FIG. 5, if a left eye image 500 and a right eye image 600 having original resolution are received by the receiving unit 110, the down-scaling unit 120 performs down-scaling to output a left eye image 510 and a right eye image 610 having low resolution.

A stereo matching process is performed with regard to the left eye image 510 and the right eye image 610 which have low resolution so that a cost volume 520 may be calculated. Accordingly, a depth having the least cost volume is selected for each pixel and a depth map 530 is generated.

The stereo matching process requires considerable amount of computation, and the computational burden may be reduced if down-scaling is performed to lower resolution of an image and stereo matching is performed on the image of low-resolution to make an algorithm less complicated. However, if the stereo matching is performed using a simple method, the image quality of the composite image may be deteriorated. Accordingly, in the exemplary embodiment, an adaptive weighted window-based stereo matching algorithm is used, which will be explained later in detail.

Meanwhile, if the depth map 530 is generated, up-scaling is performed using one of the depth map 530 and an input image of original resolution (in the case of FIG. 5, the left eye image 500). That is, if simple up-scaling is performed with regard to the depth map 530 of low-resolution, image quality may be deteriorated. Accordingly, a weight window is generated based on the left eye image 500 of original resolution and up-scaling is performed by applying the weight window to the depth map 530, so that large scale up-scaling may be performed with respect to a specific portion while relatively small scale up-scaling may be performed with respect to a portion such as background.

Specifically, the left eye image 500 of original resolution may be divided by block so as to compare and review the similarity in pixel values of each block. A weight window may be generated by applying high weight to the portions having similarity based on the review of the similarity of the pixel values. Subsequently, up-scaling is performed by applying the generated weight window to the same portion on the depth map 530 of low-resolution. Accordingly, a subject except for background, especially an edge may be up-scaled with high weight, thereby preventing deterioration of image quality.

As such, if a depth map 540 of high-resolution is prepared through up-scaling, a multi-view images 700-1˜700-n are generated by referring to the input image 500 of original resolution. The number of a multi-view image may differ according to an exemplary embodiment. For example, nine multi-view images may be used.

In FIG. 5, up-scaling is performed using a depth map of a left eye image 510 and the left eye image 500 of original resolution, but this is only an example and thus, is not limited thereto.

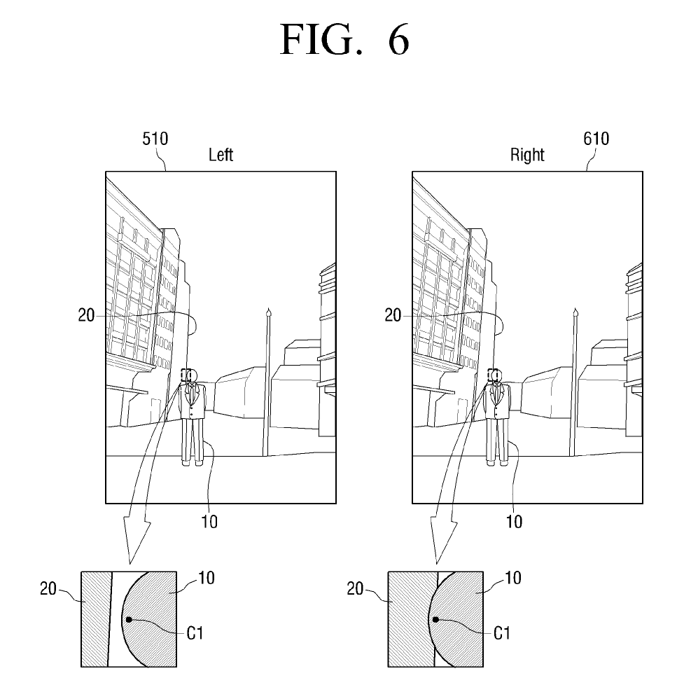

FIG. 6 is a view to explain a process of applying a window to each of a left eye image and a right eye image of low resolution. According to FIG. 6, a window is generated on the left eye image 510 and the right eye image 610 sequentially. The window has each pixel of the images as a central pixel, respectively. In this case, there may be a portion where a border of background looks similar to that of a figure. Since the viewpoint of the left eye image and the right eye image is different from each other, the background and the figure may look apart or overlapped depending on a location relation between the background and the figure.

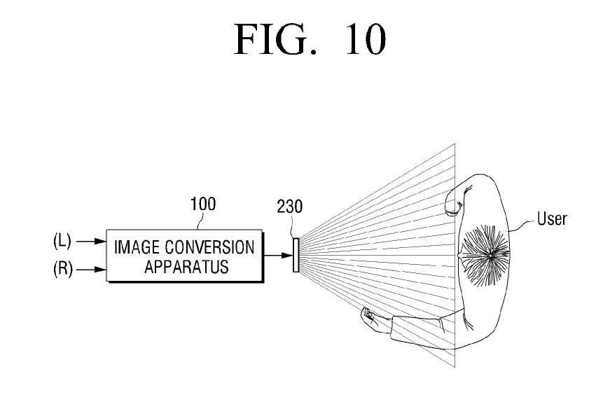

That is, if the background 20 is on the left side of the FIG. 10 as illustrated in FIG. 6, the background 20 looks somewhat apart from the FIG. 10 in a window (a) of the left eye image 510 where a pixel (C1) is designated as a central pixel, while the background 20 looks overlapped with the FIG. 10 in a window (b) of the right eye image 610 where a pixel (C2) is designated as a central pixel.

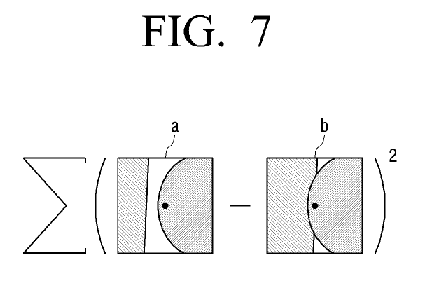

FIG. 7 illustrates a process of producing a matching level using a window (a) applied to a left eye image and a window (b) applied to a right eye image. As illustrated in FIG. 7, each pixel value of the right eye image window (b) is directly subtracted from each pixel value of the left eye image window (a) and squared to determine whether it is matching or non-matching. In this case, the pixel of the windows (a, b) of a left eye image and a right eye image may appear quite differently on the border between background and a figure as illustrated in FIG. 6, showing low matching level.

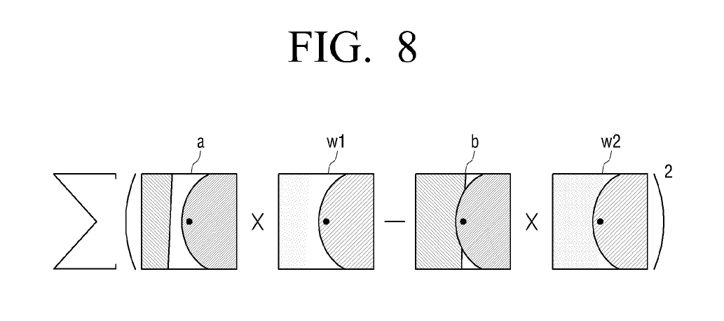

FIG. 8 illustrates a process of producing a matching degree using a weight window according to an exemplary embodiment. According to FIG. 8, a first weight window (w1) regarding a left eye image window (a) and a second weight window (w2) regarding a right eye window image (b) are used.

The first weight window (w1) and the second weight window (w2) may be obtained based on a left eye image and a right eye image, respectively. That is, for example, in the first weight window (w1), the pixel value of a central pixel (C1) is compared with pixel values of peripheral pixels in a left eye image window (a). Accordingly, a high weight is applied to a peripheral pixel having a pixel value which is the same as that of the central pixel (C1) or within a predetermined range of difference. That is, since the central pixel (c1) is a pixel constituting a figure in the window (a), a high weight is applied to other pixels constituting the figure. On the other hand, relatively low weight is applied to the remaining pixels except for those constituting the figure. If there are weights of ‘0’ and ‘1’, ‘1’ may be applied to pixels corresponding to the figure and ‘0’ may be applied to the remaining pixels. As such, the first weight window (w1) may be generated. The second weight window (w2) may also be generated in a similar way based on the right eye image window (b).

In this case, if the first and the second weight windows (w1, w2) are generated and multiplied by the left eye image window (a) and the right eye image window (b), respectively. Subsequently, the product of the second weight window (w2) and the right eye image window (b) is subtracted from the product of the first weigh window (w1) and the left eye image window (a), and the result is squared, and whether it is matching or not is determined based on the calculated value. As such, each window (a, b) is multiplied by a weight window and thus, whether it is matching or not may be determined based on a main portion which is a figure while minimizing the influence of background. Accordingly, determining a window regarding a border between background and a figure as a non-matching point due to the influence of the background may be prevented, as illustrated in FIG. 6.

If matching points between the left eye image 510 and the right eye image 610 which have low-resolution are searched, respectively, as illustrated in FIG. 8, the cost volume 520 is provided by calculating a distance between the matching points. Accordingly, a depth map having a grey level corresponding to the calculated distance is generated. Subsequently, up-scaling is performed using the generated depth map and the input image of original resolution.

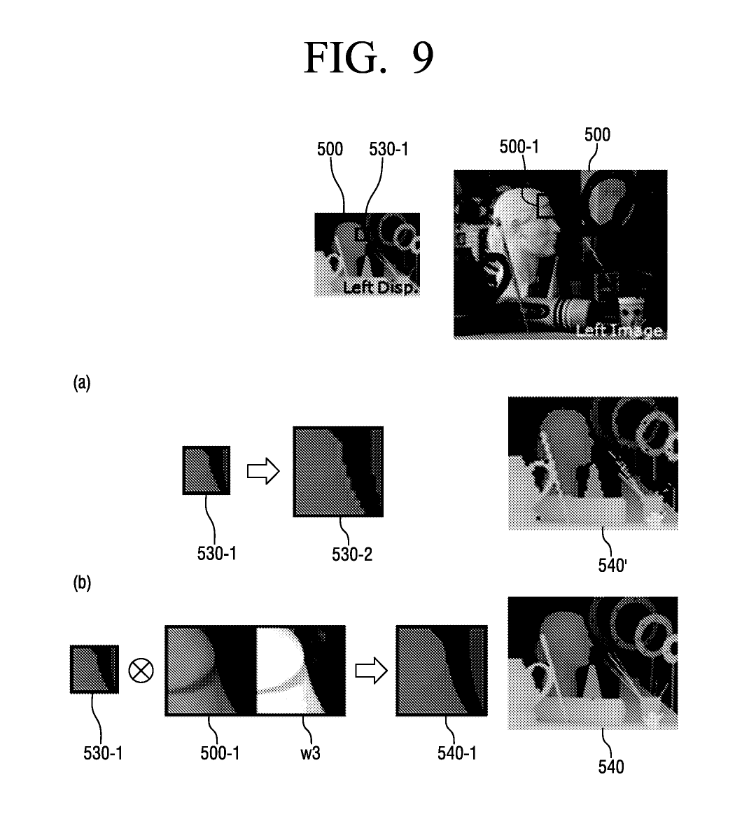

FIG. 9 is a view to explain an up-scaling process according to an exemplary embodiment. FIG. 9 illustrates image quality when up-scaling is performed with respect to the depth map 530 of a left eye image in a low-resolution state in the case (a) where the left eye image 500 of original resolution is not considered and in the case (b) where the left eye image 500 of original resolution is considered.

First of all, FIG. 9 (a) illustrates the case where the depth map 530-1 of low-resolution is directly up-scaled without referring to the left eye image 500 of original resolution. In this case, a method for simply increasing resolution by interpolating a pixel at a predetermined interval or in a predetermined pattern may be used according to a usual up-scaling method. In this case, up-scaling on an edge portion may not be performed appropriately and thus, the edge may be not be expressed but looks dislocated on the up-scaled depth map 530-2. Accordingly, the entire image quality of the depth map 540′ is deteriorated.

On the other hand, FIG. 9 (b) illustrates a process of up-scaling the depth map of low-resolution by referring to the left eye image 500 of original resolution. First of all, a window 530-1 is applied to each pixel of the depth map 530 of low-resolution. Subsequently, from among the windows in the left eye image 500 of original resolution, a window 500-1 matching to the depth map window 530-1 is searched, and then a weight window (w3) is generated with regard to the searched window 500-1. The weight window (w3) represents a window in which weight is applied to each pixel of a window using similarity between a central pixel and its peripheral pixels in the window 500-1. Therefore, up-scaling may be performed by applying the generated weight window (w3) to the depth map window 530-1. Accordingly, it can be seen that an up-scaled depth map window 540-1 has a smooth edge unlike the depth map window 530-2 of FIG. 9 (a). As a result, if the entire depth map windows 540-1 are combined, the depth map 540 of high-resolution is generated. Compared with the up-scaled depth map 540′ which is up-scaled without referring to an input image of original resolution as in FIG. 9 (a), the up-scaled depth map 540 which is up-scaled by referring to an input image of original resolution as in FIG. 9 (b) has better image quality.

FIG. 10 is a view to explain a process of representing a 3D display using a multi-view image generated using the up-scaled depth map 540 and an input image of original resolution.

According to FIG. 10, a stereo input is performed, that is, the left eye image (L) and the right eye image (R) are input to the image conversion apparatus 100. The image conversion apparatus 100 processes the left eye image and the right eye image using the above-described method to generate a multi-view image. Subsequently, the multi-view image is displayed through the display unit 230 using a space division method. Accordingly, a user may view a subject from a different viewpoint depending on a location and thus, may feel stereoscopic sense without wearing glasses.

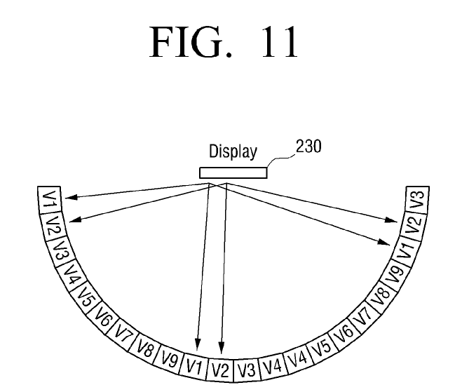

FIG. 11 is a view illustrating an example of a method for outputting a multi-view image. According to FIG. 11, the display unit 230 outputs a total of nine multi-view images (V1 to V9) in a direction according to which space is divided. As illustrated in FIG. 11, the first image is output again after the ninth image is output from the left. Accordingly, even if a user is positioned at the side the display unit 230 instead of in front of the display unit 230, the user still may feel a stereoscopic sense. Meanwhile, the number of multi-view image is not limited to nine, and the number of display direction may differ according to the number of multi-view image.

As such, according to various exemplary embodiments, a stereo image may be converted into a multi-view image effectively, and thus applicable to a non-glasses 3D display system and other display systems.

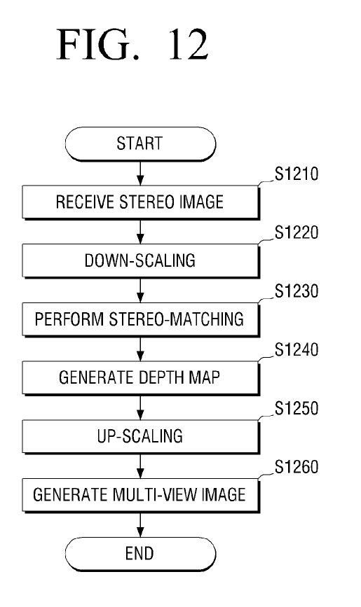

FIG. 12 is a flowchart to explain a method for converting an image according to an exemplary embodiment.

According to FIG. 12, if a stereo image is received (S1210), down-scaling is performed with respect to each image (S1220). Herein, the stereo image represents a plurality of images photographed from a different viewpoint. For example, a stereo image may be a left image and a right image, that is, a left eye image and a right eye image which are photographed from two viewpoints which are apart from each other as much as binocular disparity.

Subsequently, a matching point is searched by applying a window to each of down-scaled images. That is, stereo matching is performed (S1230). In this case, a weight window in which weight is applied considering similarity between pixels in the window may be used.

As a matching point is searched, a depth map is generated using a distance difference between corresponding points (S1240). Subsequently, the generated depth map is up-scaled (S1250). In this case, up-scaling may be performed by applying weight to a specific portion considering an input image of original resolution. Accordingly, up-scaling may be focused more on a main portion such as an edge, preventing deterioration of image quality.

After up-scaling is performed as described above, a multi-view image is generated using the up-scaled depth map and the input image of original resolution (S1260). Specifically, after one multi-view image is generated, the remaining multi-view images are generated based on the generated multi-view image. If this operation is performed in an image conversion apparatus provided separately from a display apparatus, there may be additional step of transmitting the generated multi-view image to a display apparatus, especially, a non-glasses 3D display system. Accordingly, the multi-view image may be output as a 3D screen. Alternatively, if the operation is performed in a display apparatus itself, there may be an additional step of outputting the generated multi-view image to a 3D screen.

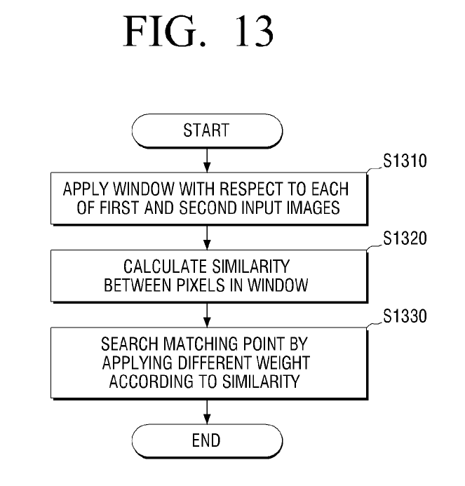

FIG. 13 is a flowchart to explain an example of a stereo matching process using a weighted window. According to FIG. 13, a window is applied to a first input image and a second input image, respectively (S1310).

Subsequently, similarity between pixels is calculated by checking each pixel value in the window (S1320).

Accordingly, weight windows regarding each of the first input image window and the second input image window are generated by applying a different weight according to the similarity. Subsequently, whether it is matching or not is determined by applying the generated weight windows to the first input image window and the second input image window, respectively (S1330).

Meanwhile, a matching point may be compared while one window is applied to one pixel of the first input image and a window is moved with respect to the entire pixels of the second input image. Subsequently, a window may be applied to the next pixel of the first input image again and the new window may be compared with the entire windows of the second input image again. As such, a matching point may be searched by comparing the entire windows of the first input image and the entire windows of the second input image.

As described above, according to various exemplary embodiments, a plurality of multi-view images may be generated by converting a stereo image signal appropriately. Accordingly, contents consisting of a conventional stereo image may be utilized as multi-view image contents.

In addition, a method for converting an image according to various exemplary embodiments may be stored in various types of recording media to be embodied as a program code executable by a CPU.

Specifically, a program for performing the above-mentioned image conversion method may be stored in Random Access Memory (RAM), flash memory, Read Only Memory (ROM), Erasable Programmable ROM (EPROM), Electronically Erasable and Programmable ROM (EEPROM), register, hard-disk, removable disk, memory card, USB memory, or CD-ROM, which are various types of recording media readable by a terminal.

Although a few embodiments of the inventive concept have been shown and described, it would be appreciated by those skilled in the art that changes may be made to the embodiments without departing from the principles and spirit of the inventive concept, the scope of which is defined in the claims and their equivalents.

1. A method for converting an image in an image conversion apparatus, the method comprising:
down-scaling a stereo image;
performing stereo-matching by applying adaptive weights to the down-scaled stereo image;
generating a depth map according to the stereo-matching;
up-scaling the depth map by referring to an input image of original resolution; and
generating a plurality of multi-view images by performing depth-image-based rendering with respect to the up-scaled depth map and the input image of original resolution.

2. The method as claimed in claim 1, wherein the stereo-matching further comprises:
applying a window having a predetermined size to each of a first input image and a second input image of the stereo image, sequentially;
calculating a similarity between a central pixel and a peripheral pixel in each of the windows; and
searching for matching points between the first input image and the second input image by applying the different adaptive weights according to the calculated similarity between the central pixel and the peripheral pixel.

3. The method as claimed in claim 2, wherein the depth map is an image having a different grey level according to distance difference between the matching points.

4. The method as claimed in claim 3, wherein the adaptive weight increases in proportion to similarity of the central pixel,
wherein the grey level is set as a value in inverse proportion to distance difference between the matching points.

5. The method as claimed in claim 2, wherein the up-scaling the depth map comprises:
searching for a similarity between the depth map and the input image of original resolution; and
performing up-scaling with respect to the depth map by applying the adaptive weight with respect to the searched similarity.

6. The method as claimed in claim 1, wherein the plurality of multi-view images are displayed by a non-glasses 3D display system to represent a 3D screen.

7. An image conversion apparatus, comprising:
a down-scaling unit which down-scales a stereo image;
a stereo-matching unit which performs stereo-matching by applying adaptive weight to the down-scaled stereo image and generates a depth map according to the stereo-matching;
an up-scaling unit which up-scales the depth map by referring to an input image of original resolution; and
a rendering unit which generates a plurality of multi-view images by performing depth-image-based rendering with respect to the up-scaled depth map and the input image of original resolution.

8. The apparatus as claimed in claim 7, wherein the stereo-matching unit comprises:
a window generating unit which applies a window having a predetermined size to each of a first input image and a second input image of the stereo image, sequentially;
a similarity-calculating unit which calculates a similarity between a central pixel and a peripheral pixel in the window of each of the first input image and the second input image;
a search unit which searches for matching points between the first input image and the second input image by applying different adaptive weights according to the calculated similarity between the central pixel and the peripheral pixel in the window of each of the first input image and the second input image; and
a depth map generating unit which generates a depth map using a distance between the searched matching points.

9. The apparatus as claimed in claim 8, wherein the depth map is an image having a different grey level according to a distance difference between the matching points.

10. The apparatus as claimed in claim 9, wherein the adaptive weights are set to increase in proportion to a similarity with the central pixel,
wherein the grey level is set as a value in inverse proportion to the distance difference between the matching points.

11. The apparatus as claimed in claim 8, wherein the up-scaling unit searches similarity between the depth map and the input image of original resolution and performs up-scaling by applying the adaptive weights with respect to the calculated similarity.

12. The apparatus as claimed in claim 7, further comprising:
an interface unit which provides the plurality of multi-view images to a non-glasses 3D display system.

13. The apparatus as claimed in claim 7, further comprising a receiving unit which receives the stereo image.

14. A display apparatus, comprising:
a receiving unit which receives a stereo image;
an image conversion processing unit which generates a depth map by applying adaptive weights after down-scaling the stereo image and generates a multi-view image through up-scaling using the generated depth map and a resolution image; and
a display unit which outputs the multi-view image generated by the image conversion processing unit.

15. The display apparatus as claimed in claim 14, wherein the image conversion processing unit comprises:
a down-scaling unit which down-scales the stereo image;
a stereo-matching unit which performs stereo-matching by applying adaptive weight with respect to the down-scaled stereo images and generates a depth map according to the stereo-matching;
an up-scaling unit which up-scales the depth map by referring to an input image of original resolution; and
a rendering unit which generates a plurality of multi-view images by performing depth-image-based rendering with respect to the up-scaled depth map and the input image of original resolution.

16. The display apparatus as claimed in claim 14, wherein the display apparatus includes one of a TV, PC monitor, digital photo frame, PDP, and a mobile phone.

17. The method as claimed in claim 1, comprising receiving the stereo image.
